(19) United States
(12) Patent Application Publication
(10) Pub. No.: US 2024/0069151 A1
(43) Pub. Date: Feb. 29, 2024

(54) A FRAME DESIGN FOR JOINT SENSING AND COMMUNICATIONS USING POSITION MODULATION

(71) Applicant: ISTANBUL MEDIPOL UNIVERSITESI, Bakirkoy, Istanbul (TR)

(72) Inventors: Saira RAFIQUE, Istanbul (TR); Hüseyin ARSLAN, Istanbul (TR)

(21) Appl. No.: 18/259,845

(22) PCT Filed: Dec. 26, 2021
(86) PCT No.: PCT/TR2021/051514

§ 371 Date: Jun. 29, 2023

(30) Foreign Application Priority Data
Dec. 31, 2020 (TR) 2020 22842

(51) Int. Cl. G01S 7/00; G01S 7/02; G01S 13/931

(52) U.S. Cl. CPC G01S 7/006; G01S 7/0234; G01S 13/931

(57) ABSTRACT

A Frame Design for Joint Sensing and Communications using Position Modulation A method for frame design of radar and communication system is proposed which consists of following steps: a. Splitting incoming information bits (70) by bit splitter (40) b. The bits are splitted as b1 and b2. c. b1 bits are used to define the position of radar sequence over the time axis (b). d. After identifying the position for the radar sequence; the radar sequence is transmitted over that position via (c). e. the remaining b2 bits are BPSK modulated and are transmitted over the remaining positions through (d).

### TECHNICAL FIELD

The invention is a method for frame design for joint sensing and communication systems.

In the proposed method; a subset of incoming information bits is allocated for radar sensing over the time axis. This subset of information bits will decide where the radar sequence should be embedded over the time axis in the frame structure of Dual-Functional Radar Communication system.

### PRIOR ART

Next Generation of wireless communication offers several high-rate and high-quality wireless applications such as air traffic control, autonomous driving and security applications that require both sensing and sending capabilities [1]. These bandwidth hungry wireless communication applications require carrier frequencies that are typically assigned to radar systems. Moreover, there is also a need to limit electromagnetic pollution caused by human activities that use electrical and electromagnetic energy. All these factors have pushed the scientific community to merge radar and communication systems.

Over the past few years, the study of coexistence between radar sensing and communication systems using similar bandwidths has gained momentum. Different techniques/scenarios have been proposed to make the radar-communication coexistence possible [2]. A frame structure that consists of both radar and communication sequences satisfies the functions of simultaneous sensing and communication.

In the literature, there are several deployment mechanisms to implement “Joint Radar and Communications”. These are Coexistence and Co-design [3]. In the Coexistence scenario, both radar and communication system independently exist sharing the same spectral resources. However, because of sharing the same frequency band; radar and communication systems cause interference with each other. Therefore, the main focus in this topology is to manage the interference at the receiver [3].

Co-Design focuses on designing of a single waveform that is capable of performing both sensing and sending functionalities. This is also termed in the literature as DFRC (Dual-Function Radar Communications). Recent experiments validated the superposition of data in the chirp subcarrier of the multi-carrier waveform using Fractional Fourier Transform (FrFT) [4].

In Rad-Com (Communications used by Radar) systems, the radar signal is used to send the data. The traditional way is to embed information in the radar chirps. However, data throughput is not sufficient in such radar-centric JRC systems for several wireless applications.

Whereas, in communication centric radar systems (Com-Rad); communication waveforms such as OFDM have been used for efficient target-detection [5]. This concept is analogous to passive radars. However, use of multicarrier waveforms (OFDM) for radar sensing has issue of high peak-to-average-power-ratio (PAPR) which makes it difficult for amplifiers to work well when high transmission powers are used.

In coexistence scenario between radar and communication, both subsystems must operate independently while sharing the same spectral resources. Such network settings are not cost-effective. Moreover, interference between radar and communication signals need to be managed at the receiver. To overcome these limitations, Dual Function Radar Communication (DFRC) is used in which single transmitting unit is shared between radar and communication.

In classical communication signal, pilot signals are embedded as premable, midamble or postamble in the transmitted frame to perform channel estimation [6]. However, the sensing capability of these pilots is limited when it comes to range and doppler estimation of the target. Specifically, in applications such as vehicular communication where the high-speed moving vehicles are required to communicate with each other and share the surrounding environment information with neighboring vehicles at high data rate, these pilot symbols cease to provide desired sensing performance

As a result, due to the above-mentioned disadvantages and the inadequacy of the existing solutions, an improvement in the relevant technical field was required.

### PURPOSE OF THE INVENTION

The invention aims to provide a method with different technical characteristics which brings a new perspective in this field, unlike the embodiments used in the present art.

The purpose of this invention is to have efficient sensing and communication performance using a single DFRC frame architecture.

Another purpose of the invention is designing a framework that perform high resolution sensing and communication simultaneously.

In this invention, a novel frame design for DFRC system is proposed which is capable of efficient target sensing, channel estimation and data transmission. Consequently, the radar sequence not only performs sensing but it also carries additional information bits thereby increasing throughput of the DFRC system. Binary Phase Shift Keying (BPSK) is used for the communication. Whereas; Barker codes having high correlation property are used for radar sensing.

In this invention; radar sequences are used in lieu of pilots. Moreover, these radar sequences are placed randomly over the time-axis. This randomness incorporated in the position of radar sequence over the time-axis is exploited to transmit additional information bits. Hence, sensing sequence is also carrying additional information bits consequently increasing the data throughput.

Furthermore, similar to the concept of spatial modulation where indices of antennas carry additional information bits [7], in this invention position of the radar sequence is carrying additional information bits. Therefore, radar sensing sequence has inherent feature of information transmission and the interference between radar and communication is significantly reduced.

### Advantages of the Invention

1. Introduction of position modulation in the frame architecture of DFRC system
2. Extending the dimension of information transmission
3. Sensing sequence is leveraging the function of pilot symbols (no additional pilots are required for channel estimation).
4. Reduced interference between radar and communication symbols.
5. Sampling rate and power level of both communication and radar sequence is the same, so there will be no extra complexity in the transmission system.
6. Secure because of random position of sensing symbols.

### REFERENCES

[1] Zheng, Le, et al. “Radar and communication coexistence: An overview: A review of recent methods.” IEEE Signal Processing Magazine 36.5 (2019): 85-99.
[2] Mishra, Kumar Vijay, et al. “Toward millimeter-wave joint radar communications: A signal processing perspective.” IEEE Signal Processing Magazine 36.5 (2019): 100-114.
[3] Mishra, Kumar Vijay, et al. “Toward millimeter-wave joint radar communications: A signal processing perspective.” IEEE Signal Processing Magazine 36.5 (2019): 100-114.
[4] Gaglione, Domenico, et al. “Fractional Fourier based waveform for a joint radar-communication system.” 2016 IEEE Radar Conference (RadarConf). IEEE, 2016.
[5] Sur, Samarendra Nath, et al. “OFDM Based RADAR-Communication System Development.” Procedia Computer Science 171 (2020): 2252-2260.
[6] Arslan, Huseyin, and Gregory E. Bottomley. “Channel estimation in narrowband wireless communication systems.” Wireless Communications and Mobile Computing 1.2 (2001): 201-219.
[7] Mesleh, Raed Y., et al. “Spatial modulation.” IEEE Transactions on vehicular technology 57.4 (2008): 2228-2241.

The structural and characteristic features and all advantages of the invention will become more apparent from the following figures and the detailed description made with reference to these figures, and therefore the evaluation should be made with reference to these figures and detailed description.

### BRIEF DESCRIPTION OF THE FIGURES

FIG. 1, system model of the invention.

FIG. 2, frame design for dual function radar communication

FIG. 3, block diagram illustrating the process of invention

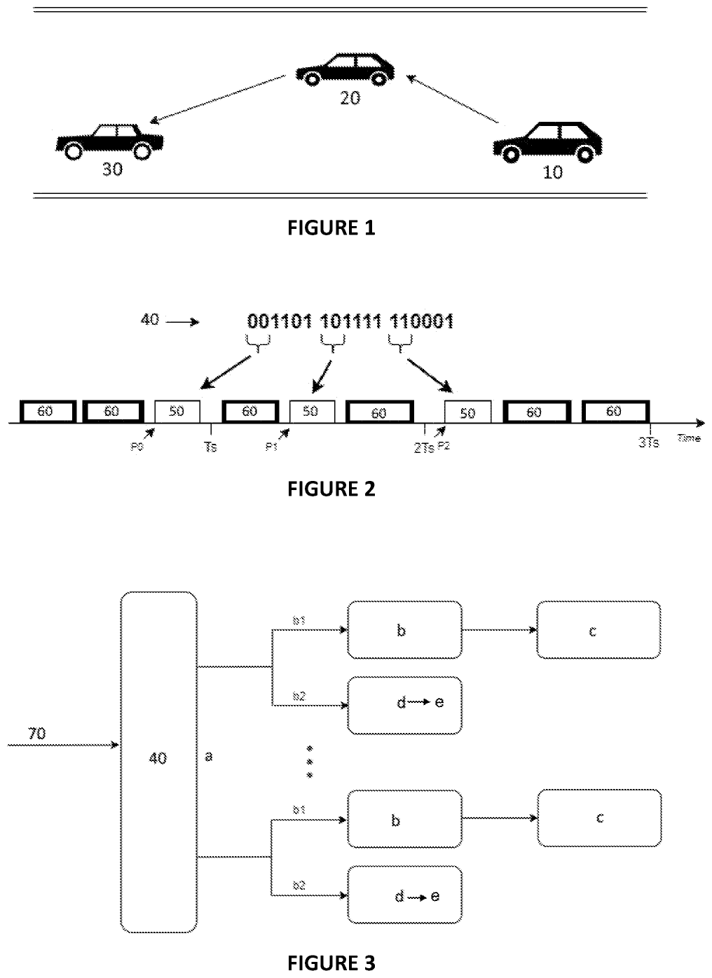

The drawings do not necessarily have to be scaled and details which are not necessary to understand the present invention may be omitted. Furthermore, elements which are at least substantially identical or at least substantially identical functions are designated by the same number.

### REFERENCE LIST

10. Radar transmitter
20. Target
30. Receiver
40. Bit splitter
50. Radar signal
60. BPSK signal
70. Information bits
b1, b2 splitted bits
a. Splitting incoming information bits (70) by bit splitter (40).
b. The bits are splitted as b1 and b2.
c. b1 bits are used to define the position of radar sequence over the time axis (b).
d. After identifying the position for the radar sequence; the radar sequence is transmitted over that position via (c).
e. the remaining b2 bits are BPSK modulated and are transmitted over the remaining positions through (d).

### Abbreviations

DFRC: Dual Function Radar Communication
OFDM: Orthogonal Frequency-Division Multiplexing
BPSK: Binary Phase Shift Keying

### DETAILED DESCRIPTION OF THE INVENTION

In this detailed description, preferred embodiments of the invention are explained for better understanding of the subject matter and with no limiting effect.

The invention is a method for frame design for joint sensing and communication systems.

System Model:

A Dual Function Radar Communication (DFRC) system consists of a shared communication and radar transmitter (10). A hybrid signal is transmitted that sends information towards the receiver (30). In addition to the information transmission, the signal is equipped with radar sensing functionality and gets information (range, angle, velocity) about the target (20).

The design of hybrid signal is illustrated in FIG. 2. Let there are b information bits. These bits are divided into N equal sized groups. The first two bits of each group will decide the position where the radar signal (50) should be embedded. Rest of the bits will be modulated with BPSK signal (60). The sampling rate and power level of both signals are same so that no additional complexity is required. The above procedure is summarized in the FIG. 3. In the proposed frame design, for communication; single carrier transmission is considered. Multicarrier waveforms such as OFDM can also be used in the frame design for communication.

Barker codes are used as radar sequence. The barker codes are the most famous phase coding scheme in radar processing. They are used in radar technology because they can perform pulse compression which is required for fine range resolution and detection range.

x(t)=e^{jω}^{₀}^{t}Σₙ₌₁^{N}Pₙ(t)e^{jθ}^{ₙ} (1)

Due to perfect autocorrelation properties, barker codes are suitable for range calculation. The autocorrelation function (a.c.f) is used to extract the time delay information of the transmitted signal and from that range of the target can be calculated with the help of following equation:

$$R = \frac{c \cdot {t}_{d}}{2} \qquad ( 2 )$$

Where c is the speed of light and td is the time delay between the transmitted and received signal. Other radar sequences/waveforms such as golay complementary codes or chirp can also be used for radar sensing.

Due to perfect autocorrelation properties of radar sequence it can easily be detected at the receiver (30) and then based on the lookup table that is used to assign different positions to the radar sequences; the information bits (70) can be extracted. After the detection of radar sequence the BPSK signal (70) can be extracted.

The above mentioned method for DFRC communication is applicable to many applications that are under the scope of 5G or beyond 5G such as vehicular communications where different high speed moving vehicles not only communicate with each other but also convey information regarding the neighbouring vehicles to avoid accidents.

Moreover, the random position of radar sequence is secure for radar sensing as it is difficult to predict the exact location of radar sequence over the time axis. The concept of transmitting information via random positioning of radar sequence can also be extended in frequency domain where radar sequence is transmitted over different carrier frequencies and that randomness is exploited to transmit additional information bits.

Another approach is to allocate a specific position to the radar sequence over the time axis; but change the waveform transmitted in each time slot and associate communication bits to that particular waveform. For instance, in first time slot if a Linear Frequency Modulated (LFM) chirp is transmitted; it would mean 01 is transmitted and likewise different waveform combinations lead to transmission of communication bits.

1. A method for frame design of radar and communication system is proposed which consists of following steps:
a. Splitting incoming information bits (70) by bit splitter (40).
b. The bits are splitted as b1 and b2.
c. b1 bits are used to define the position of radar sequence over the time axis (b).
d. After identifying the position for the radar sequence; the radar sequence is transmitted over that position via (c).
e. the remaining b2 bits are BPSK modulated and are transmitted over the remaining positions through (d).
